(19) United States
(12) Patent Application Publication
(10) Pub. No.: US 2010/0217766 A1
(43) Pub. Date: Aug. 26, 2010

(54) Mapping Courses to Program Competencies

(76) Inventors: Martin S. Perlin, Aldie, VA (US); Peggy Maddox, McLean, VA (US)

Correspondence Address: GEORGE MASON UNIVERSITY;OFFICE OF TECHNOLOGY TRANSFER, MSN 5G5, 4400 UNIVERSITY DRIVE, FAIRFAX, VA, 22030, US

(21) Appl. No.: 12/711,703

(22) Filed: Feb. 24, 2010

Related U.S. Application Data
(60) Provisional application No. 61/154,988, filed on Feb. 24, 2009.

(51) Int. Cl. G06F 17/30

(52) U.S. Cl. 707/741; 707/E17.002

(57) ABSTRACT

A mapping device configured to map accreditation data to curriculum data. A mapping device may include an accreditation module, a curriculum module and/or a mapping module. An accreditation module may be configured to retrieve accreditation data. A curriculum module may be configured to retrieve curriculum data. A mapping module may be configured to map one or more competencies and/or one or more accreditation content areas to one or more course contents and/or one or more course objectives. A mapping device may include an analytical module, which may be configured to identify deficiencies, and/or an alignment module, which may be configured to address one or more deficiencies. A mapping device may be configured to employ a linkage template, which may include an academic level, and/or may employ a leveling rubric, which may be multi-leveled. A mapping module may be configured to generate an output graph, which may implement weights.

### CROSS-REFERENCE TO RELATED APPLICATIONS

This application claims the benefit of U.S. Provisional Application No. 61/154,988, filed Feb. 24, 2009, entitled “Mapping Courses to Program Competencies,” which is hereby incorporated by reference in its entirety.

### REFERENCE TO COMPUTER PROGRAM LISTING APPENDIX

A portion of the present disclosure is contained in a computer program listing appendix filed electronically herewith as an ASCII text file, which is hereby incorporated by reference in its entirety. The ASCII text file is entitled GMU-09-024U_Listing.txt created on Feb. 24, 2010, of approximately 7,813 kilobytes.

### BRIEF DESCRIPTION OF THE SEVERAL VIEWS OF THE DRAWINGS

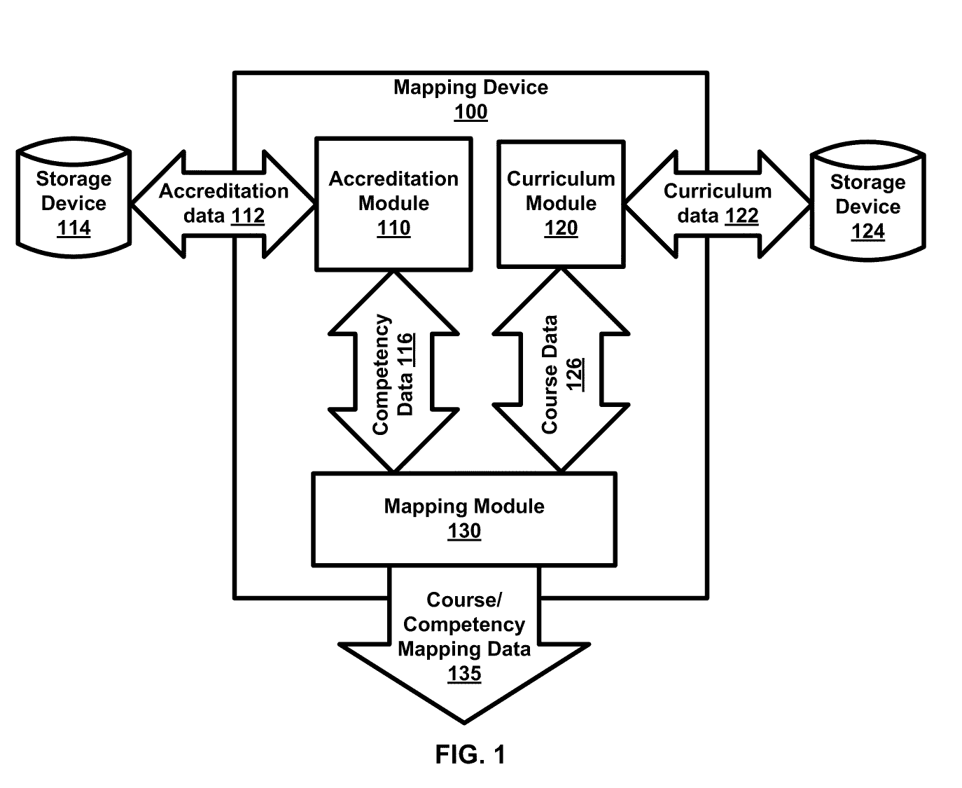

Examples FIG. 1 to FIG. 8 illustrate a mapping device in accordance with embodiments.

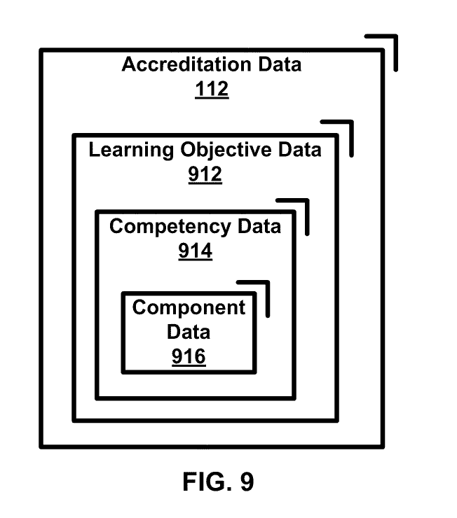

Example FIG. 9 illustrates accreditation data in accordance with embodiments.

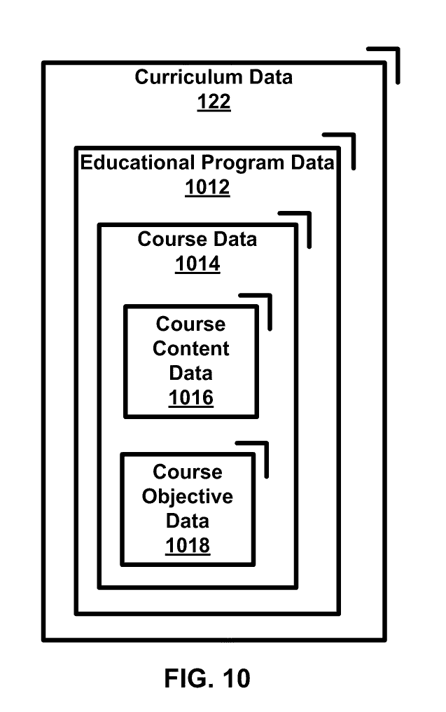

Example FIG. 10 illustrates curriculum data in accordance with embodiments.

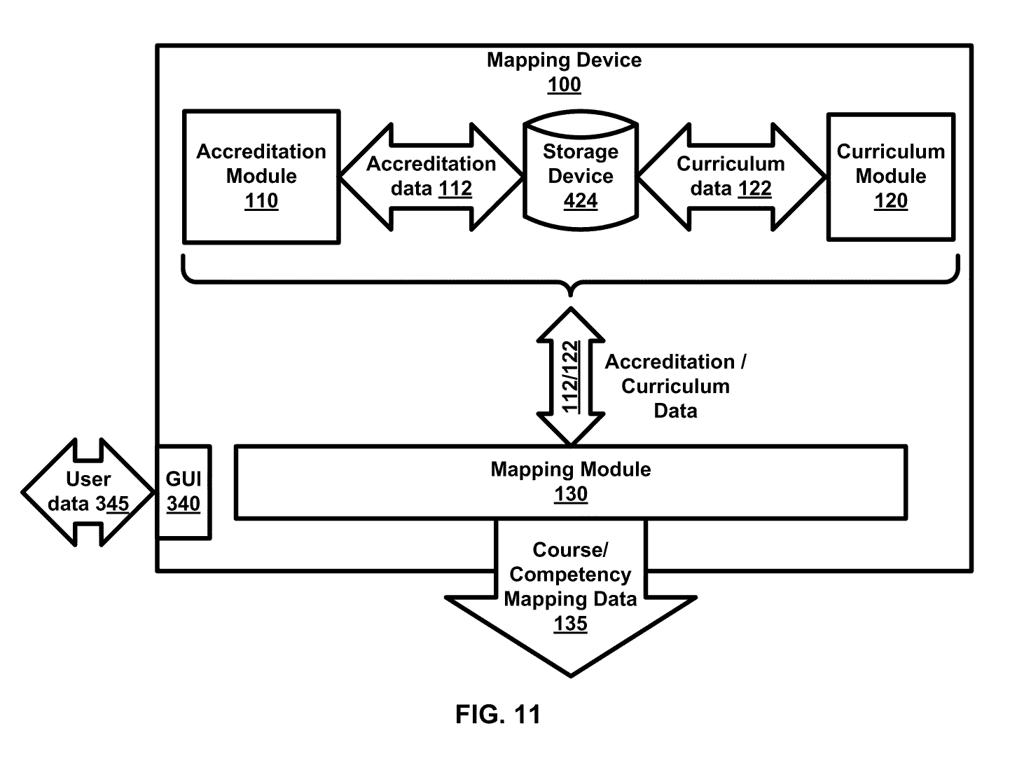

Example FIG. 11 illustrates a mapping device in accordance with embodiments.

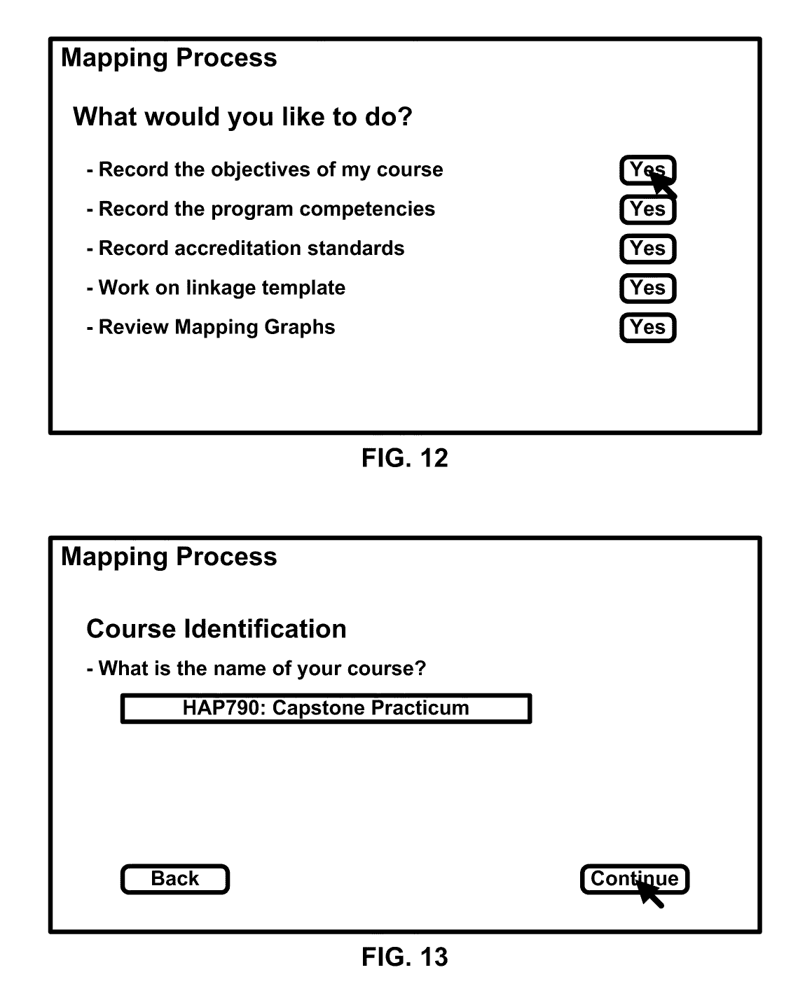

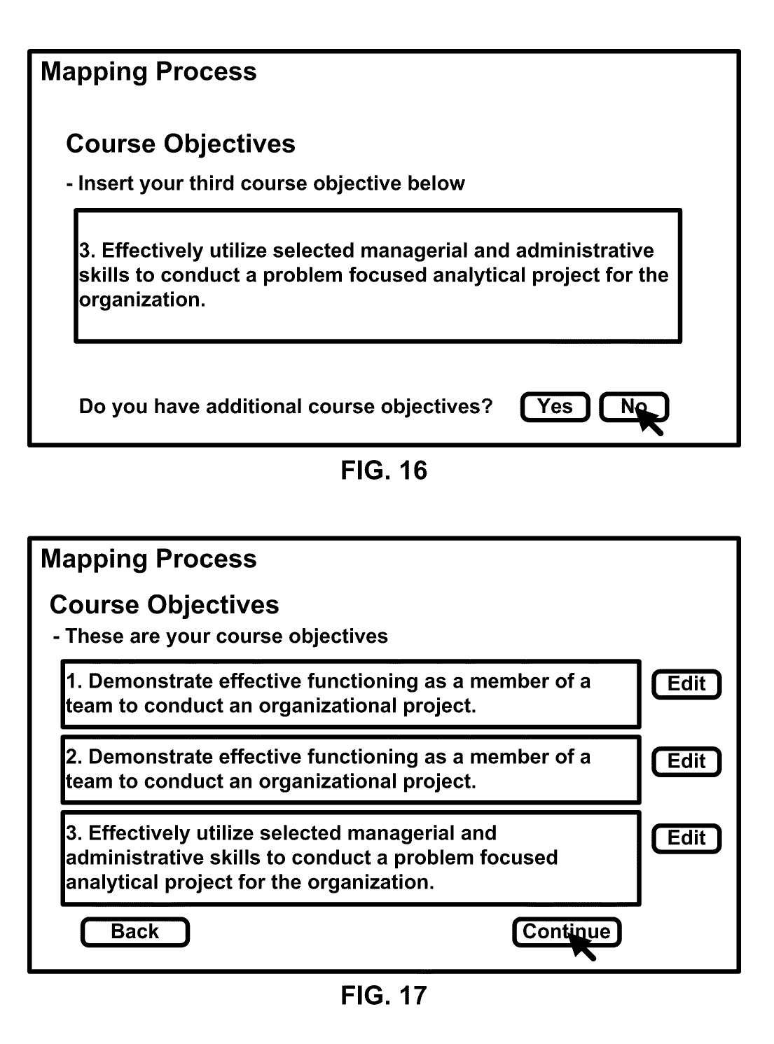

Examples FIG. 12 to FIG. 17 illustrate a mapping process employing curriculum data in accordance with embodiments.

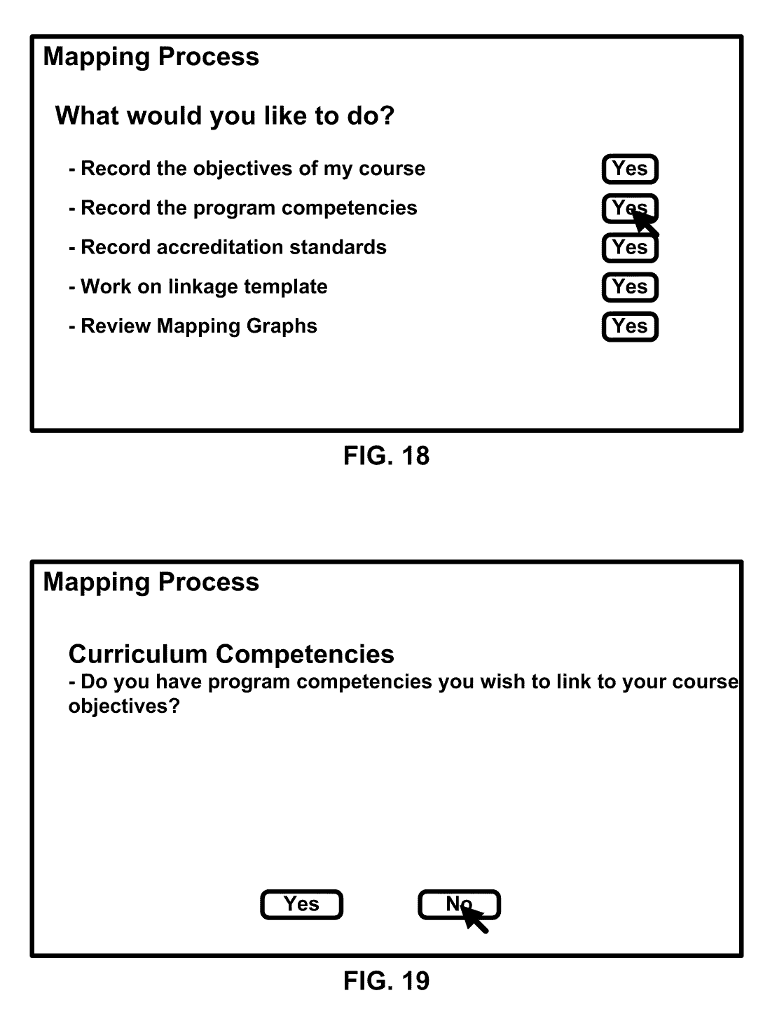

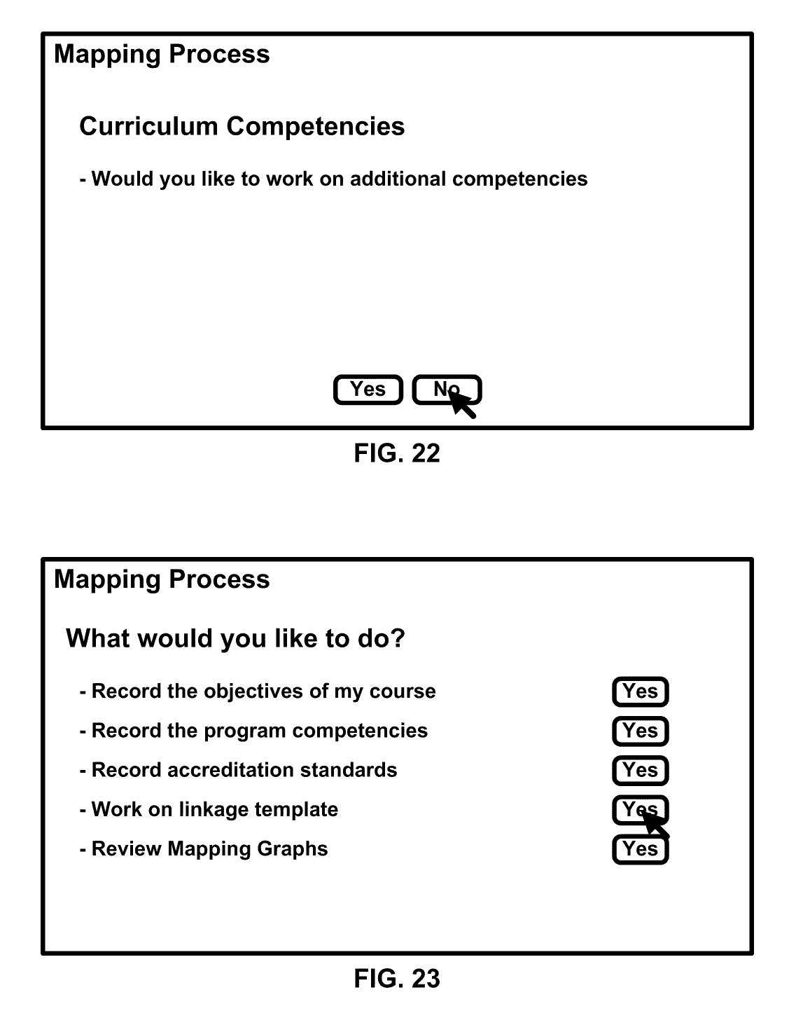

Examples FIG. 18 to FIG. 22 illustrate a mapping process employing accreditation data in accordance with embodiments.

Examples FIG. 23 to FIG. 25 illustrate a mapping process including a linkage template in accordance with embodiments.

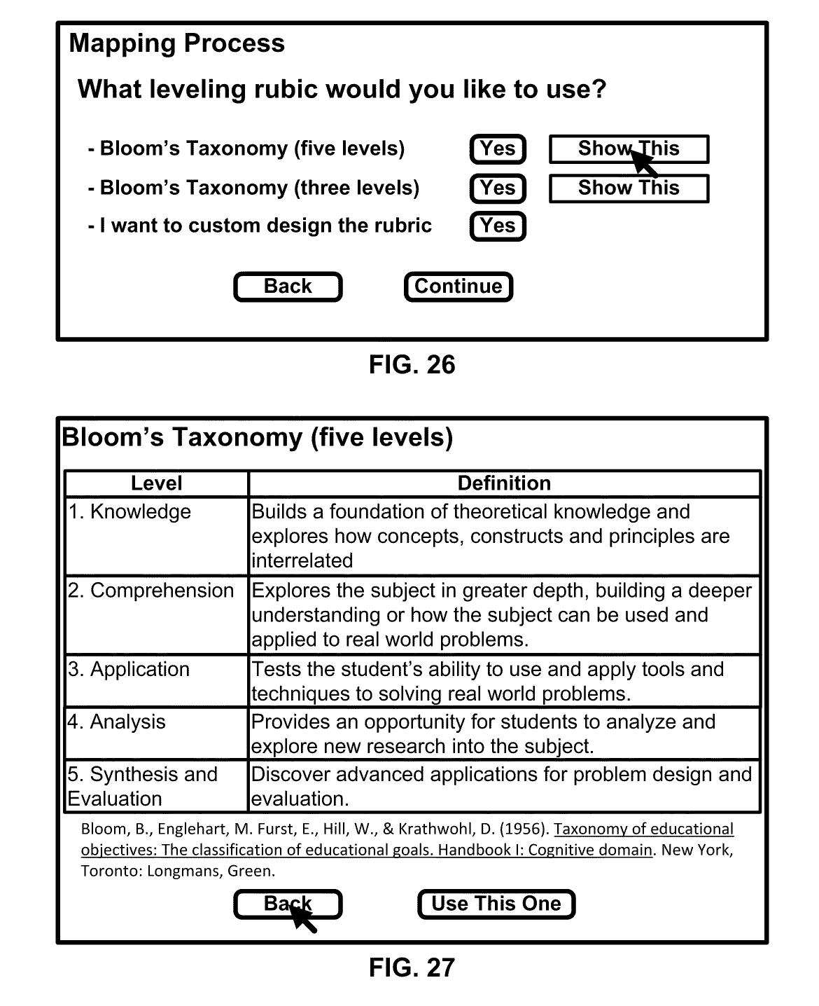

Examples FIG. 26 to FIG. 29 illustrate a mapping process including a leveling rubric in accordance with embodiments.

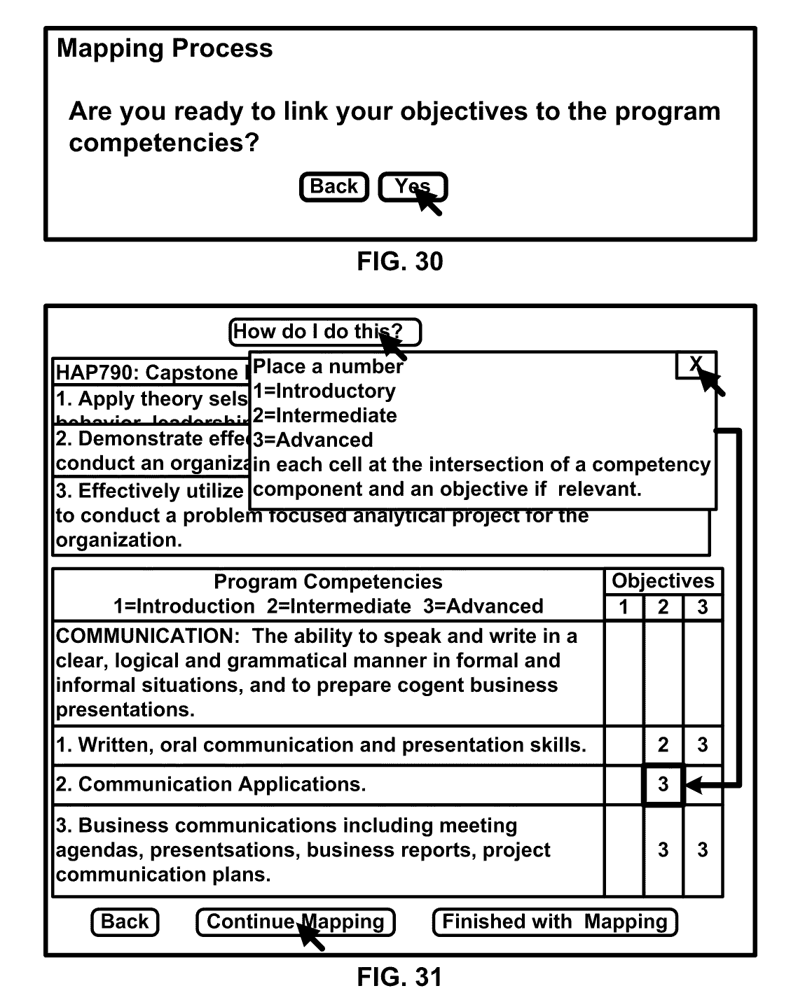

Examples FIG. 30 to FIG. 31 illustrate a mapping process linking accreditation data to curriculum data in accordance with embodiments.

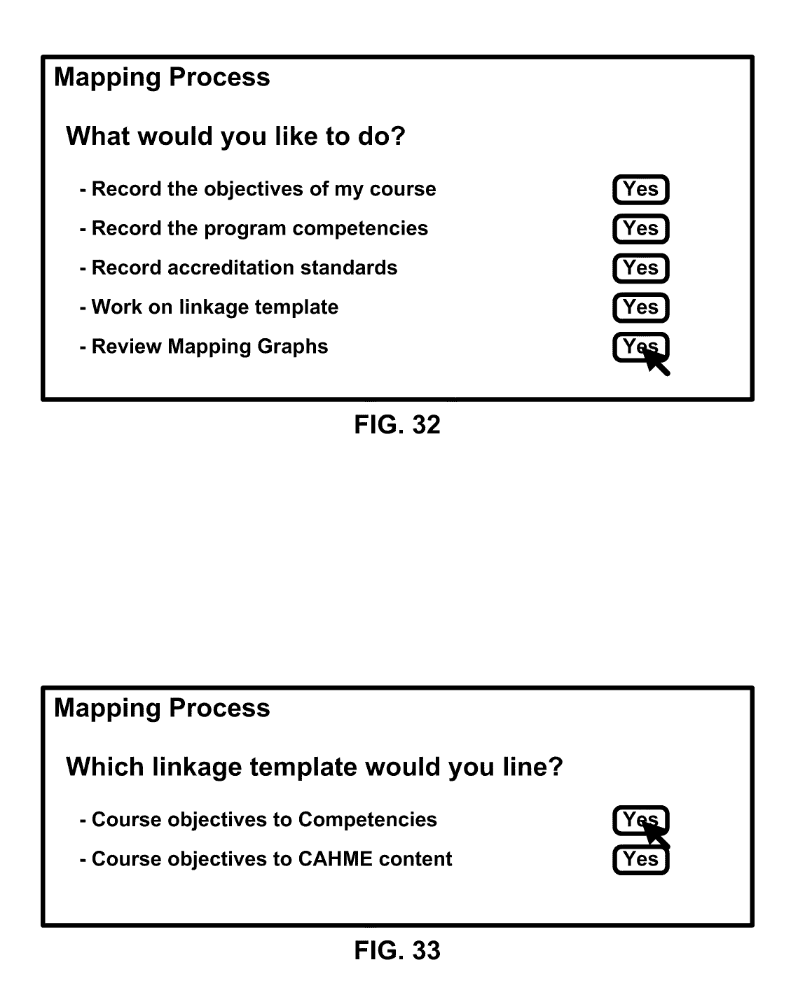

Examples FIG. 32 to FIG. 43 illustrate a mapping process output in accordance with embodiments.

### DETAILED DESCRIPTION OF EMBODIMENTS

Embodiments may relate to linking course data, such as course content and/or course learning objectives, to competencies and/or accreditation content areas, which may be useful in adopting, implementing and/or maximizing competencies as a basis of a curriculum. Embodiments may enable incorporation of current developments from a field in a course, may enable accurate reflection of course competencies and/or content areas, may maximize teaching and/or assessment process, and/or may provide relationships between courses.

According to embodiments, qualitative and/or quantitative data may be generated and/or implemented. In embodiments, in addition to determining whether a course may be involved in contributing to competencies and/or content areas, the extent of contribution may be determined and/or implemented. In embodiments, an identification of the academic level at which a course may be addressing competencies and/or content areas may be provided. In embodiments, a determination and/or implementation may be made regarding whether courses include course objectives that may be matched to competencies and/or content areas. In embodiments, the level and/or depth of contribution may be determined and/or implemented. In embodiments, the relative placement of courses and/or degree of interaction of groups of courses to address particular competencies and/or content areas may be determined and/or implemented.

Embodiments may implement a mapping device which may be configured to map courses to program competencies and/or content areas. In embodiments, mapping device 100 may include accreditation module 110, curriculum module 120 and/or mapping module 130. In embodiments, mapping device 100 may be implemented using a specifically configured computer system to manage processing requirements.

Referring to examples FIG. 1 to FIG. 8, and FIG. 11, a mapping device is illustrated in accordance with embodiments. In embodiments, accreditation module 110 may be configured to retrieve accreditation data 112, which may include one or more enumerated accreditation standard(s). Referring to example FIG. 9, accreditation data is illustrated in accordance with embodiments. In embodiments, accreditation data 112 may include one or more learning objective(s), competencies and/or component(s). In embodiments, accreditation data 112 may include learning objective data 912, which may include one or more learning objective(s). In embodiments, one or more learning objective(s) may include competency data 914, which may include one or more competencies. In embodiments, one or more competencies may include component data 914, which may include one or more component(s). In embodiments, accreditation data 122 may include content area data, which may include one or more accreditation content area(s), illustrated in one aspect of embodiments at FIG. 42. In embodiments, accreditation content area(s) may include component data, which may include one or more component(s).

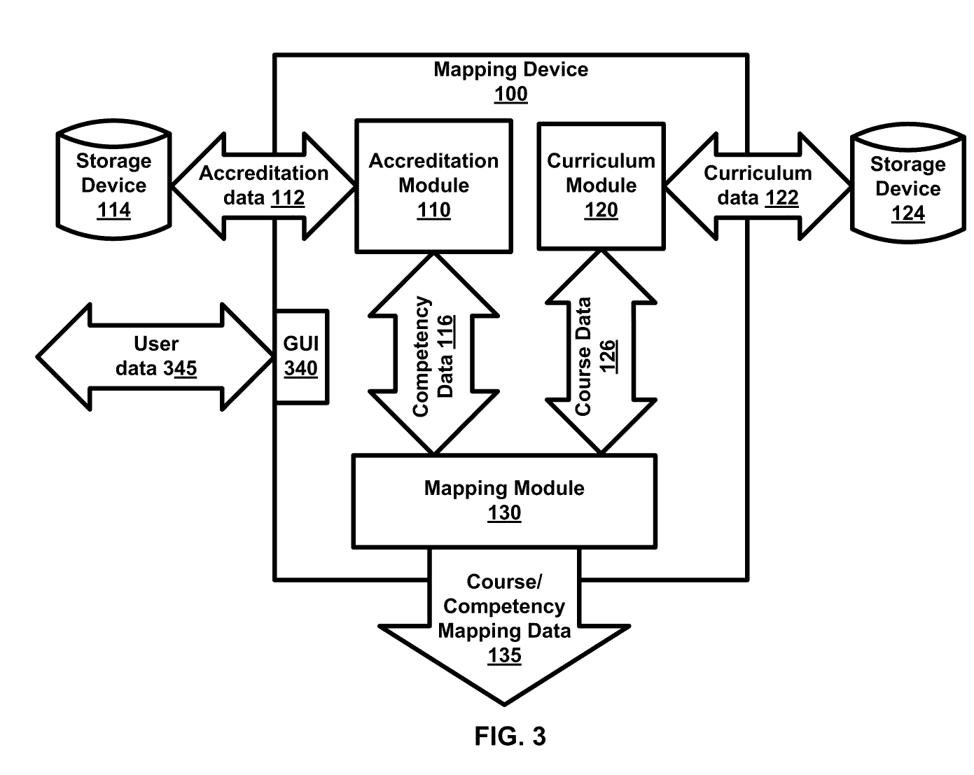

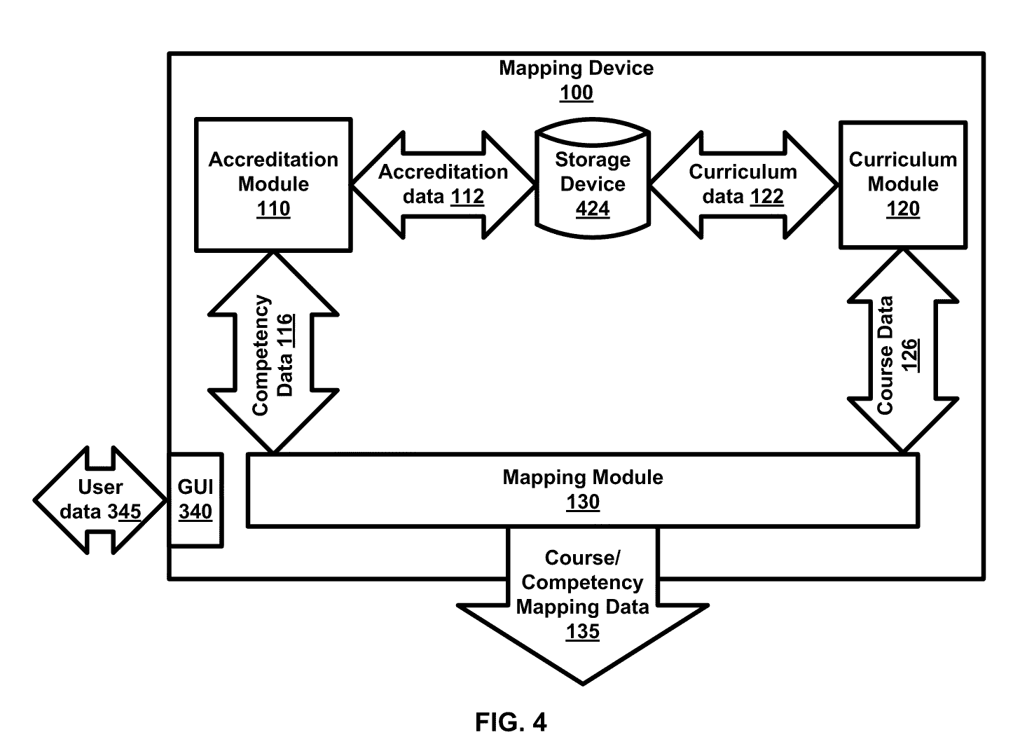

Referring back to FIG. 1 to FIG. 8, accreditation data 112 may be retrieved from one or more tangible computer readable storage medium(s) 114. In embodiments, first tangible computer readable storage medium 114 may be populated. As illustrated in one aspect of embodiments at FIG. 3 and FIG. 4, first tangible computer readable storage medium 114 may be populated employing graphical user interface 340. In embodiments, first tangible computer readable storage medium 114 may be populated using a template(s) or any other suitable population mechanism.

According to embodiments, curriculum module 120 may be configured to retrieve curriculum data 122, which may include one or more curriculum(s). Referring to example FIG. 10, curriculum data is illustrated in accordance with embodiments. In embodiments, curriculum data 122 may include an educational program(s), course(s), course content(s) and/or course objective(s). In embodiments, curriculum data 122 may include educational program data 1012, which may include one or more educational program(s). In embodiments, one or more educational program(s) may include course data 1014, which may include one or more course(s). In embodiments, one or more course(s) may include course content data 1016, which may include one or more course content(s). In embodiments, one or more course content(s) may include course objective data 1018, which may include one or more course objective(s).

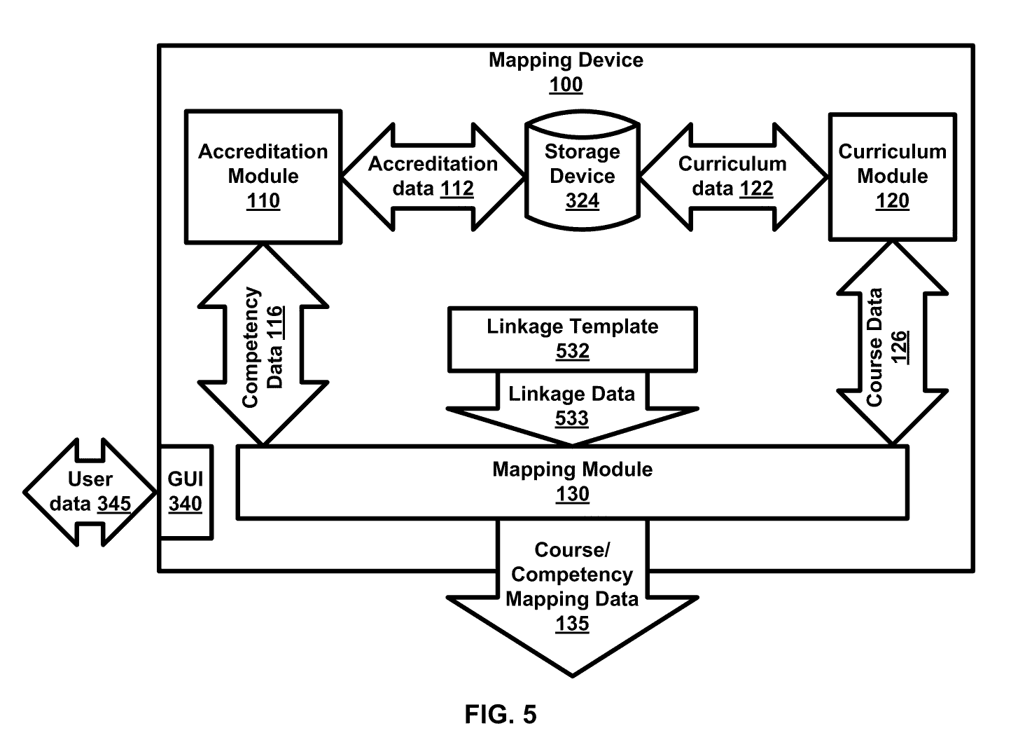

Referring back to FIG. 1 to FIG. 8, curriculum data 122 may be retrieved from one or more tangible computer readable storage mediums 124. In embodiments, second tangible computer readable storage medium 124 may be populated. As illustrated in one aspect of embodiments at FIG. 3 and FIG. 4, second tangible computer readable storage medium 124 may be populated employing graphical user interface 340. In embodiments, second tangible computer readable storage medium 124 may be populated using a template(s) or any other suitable population mechanism. In embodiments, first tangible computer readable storage medium 114 and second tangible computer readable storage medium 124 may be the same tangible computer readable storage medium, for example tangible computer readable storage medium 424 illustrated in one aspect of embodiments at FIG. 4 and/or FIG. 5.

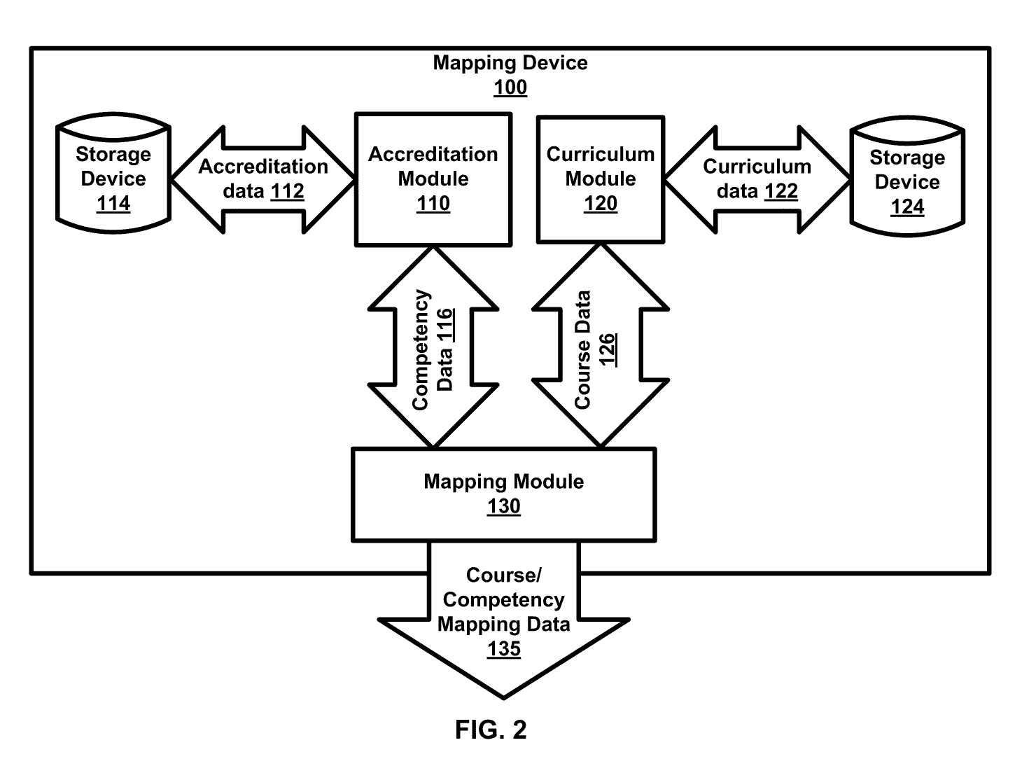

According to embodiments, a storage medium may include a networked drive shared over one or more networks, including the Internet. In embodiments, a storage medium may include a compact disc (cd), digital versatile disc (dvd), usb flash drive, floppy disk, random access memory (RAM), read-only memory (ROM), erasable programmable read-only memory (EPROM), electronic notepad or notebook, PDA, etc. As illustrated in one aspect of embodiments at FIG. 2, FIG. 4 and/or FIG. 5, a storage device may reside in mapping device 100.

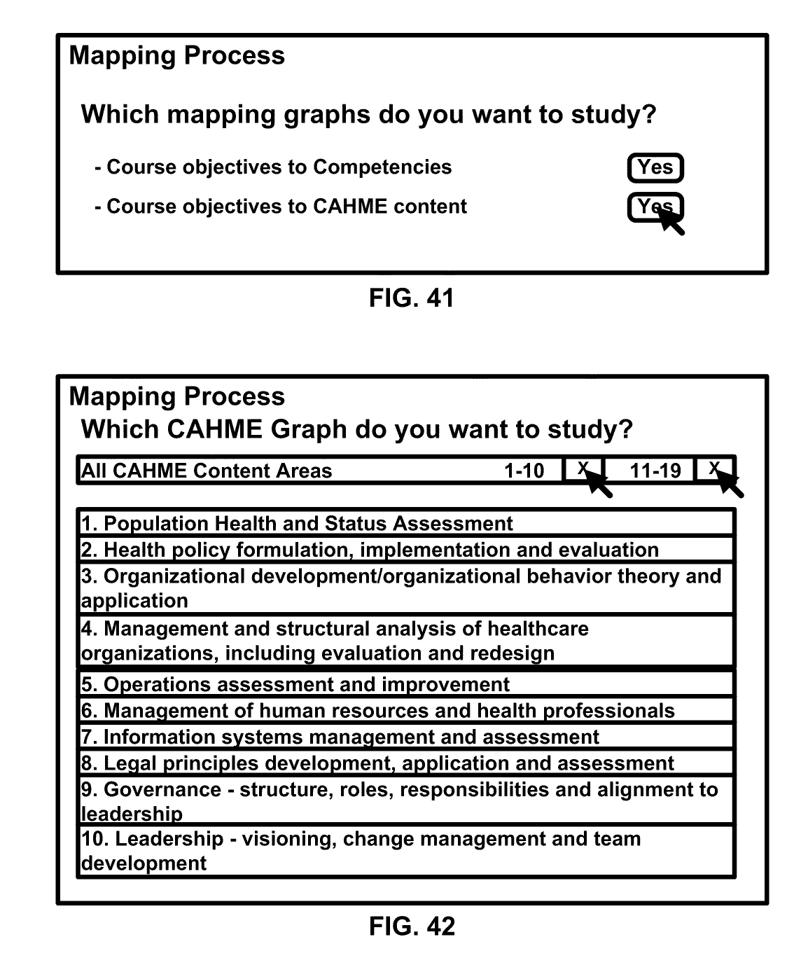

According to embodiments, mapping module 130 may be configured to link accreditation data 112, which may include competency data and/or content area data, to curriculum data 122, which may include course data. As illustrated in one aspect of embodiments at FIG. 1 to FIG. 4, mapping module 130 may be configured to link competency data 116 to course data 126. As illustrated in one aspect of embodiments at FIG. 9 and FIG.10, mapping module 130 may be configured to link competency data 914, which may include one or more competencies, to course content data 1016 and/or course objective data 1018, which may include one or more course content(s) and/or one or more course objective(s). In embodiments, any combination of accreditation data 112 and curriculum data 122 may be linked by mapping module 130, including all accreditation data 112 and curriculum data 122. In embodiments, content area data, which may include one or more accreditation content area(s), may be linked to course data, which may include course objective data, as illustrated in one aspect of embodiments at FIG. 41.

Referring to FIG. 5, mapping module 130 may employ a linkage template(s), for example linkage template 532. In embodiments, a linkage template may be used to link accreditation data, for example competency data and/or content area data, to course data, for example course objective data. In embodiments, mapping module 130 may employ linkage template 532 by implementing linkage data 533. In embodiments, linkage data 533 may be formed employing a simple linkage, employing one or more academic levels, and/or any suitable mechanism. In embodiments, linking course data formed by employing academic levels may provide linkage data related to the relative level of difficulty which a course may address a competency and/or a content area.

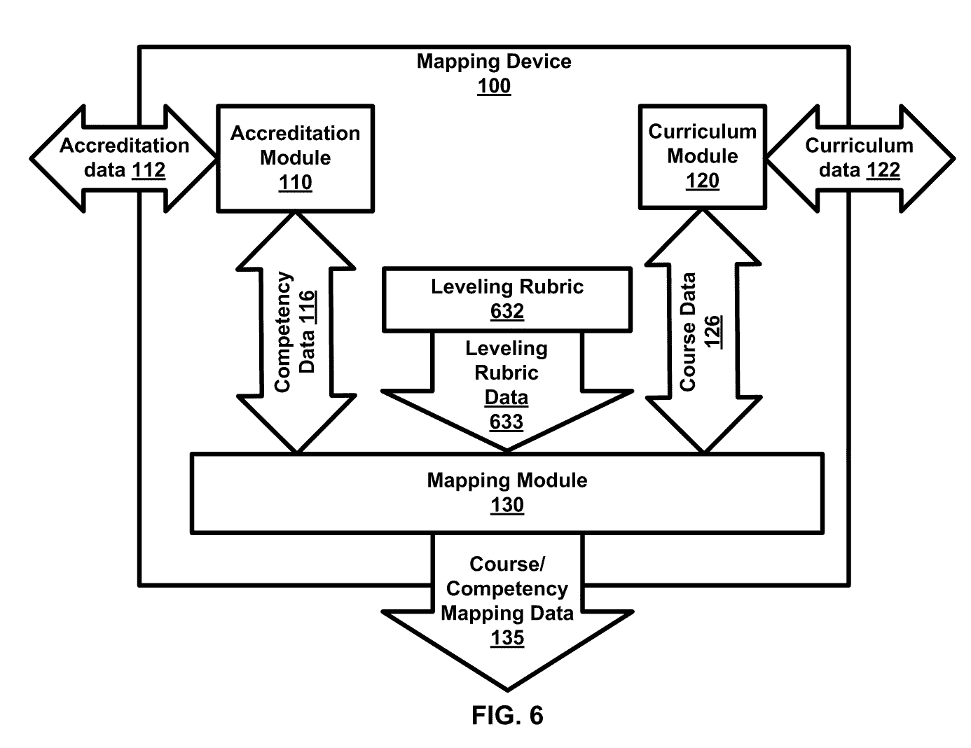

Referring to FIG. 6, mapping module 130 may employ a leveling rubric(s), for example leveling rubric(s) 632. In embodiments, a leveling rubric(s) may include a multi-level taxonomy, for example a multi-level bloom's taxonomy. In embodiments, a 5 level bloom's taxonomy may include a knowledge level, a comprehension level, an application level, an analysis level and a synthesis and evaluation level. In embodiments, a 3 level bloom's taxonomy may include an introductory level, an intermediate level and an advanced level. In embodiments, mapping module 130 may employ a leveling rubric(s) by implementing leveling rubric data 633.

According to embodiments, mapping module 130 may employ one or more curriculum weight(s) that may be associated with curriculum data 122. In embodiments, one or more curriculum weight(s) may be applied to accreditation data 112, for example to competency data and/or to content area data. In embodiments, mapping module 130 may apply one or more curriculum weight(s), which may be associated with one or more academic levels, to accreditation data 112, which may include one or more competencies and/or one or more content areas. In embodiments, an approximation of the amount of activity for accreditation data, for example in each competency, may be determined and/or implemented. In embodiments, weight(s) may be associated with accreditation data 112, such that accreditation weight(s) may be applied to curriculum data.

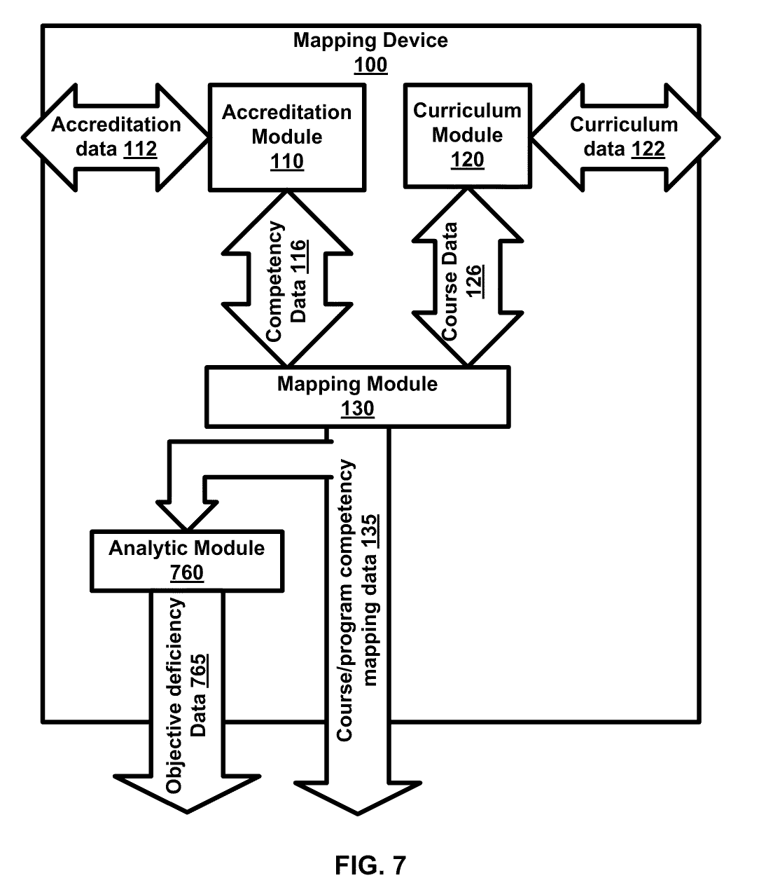

Referring to FIG. 7, mapping device 100 may include analytical module 760. According to embodiments, analytical module 760 may be configured to identify one or more deficiencies. As illustrated in one aspect of embodiments at FIG. 7, analytical module 760 may be configured to identify one or more objective deficiencies, if existing. In embodiments, analytical module 760 may identify one or more discontinuities in current pedagogy, for example when one or more predetermined thresholds are not achieved. In embodiments, analytical module 760 may identify when an academic level is not consistent, for example inconsistent relative to course sequencing.

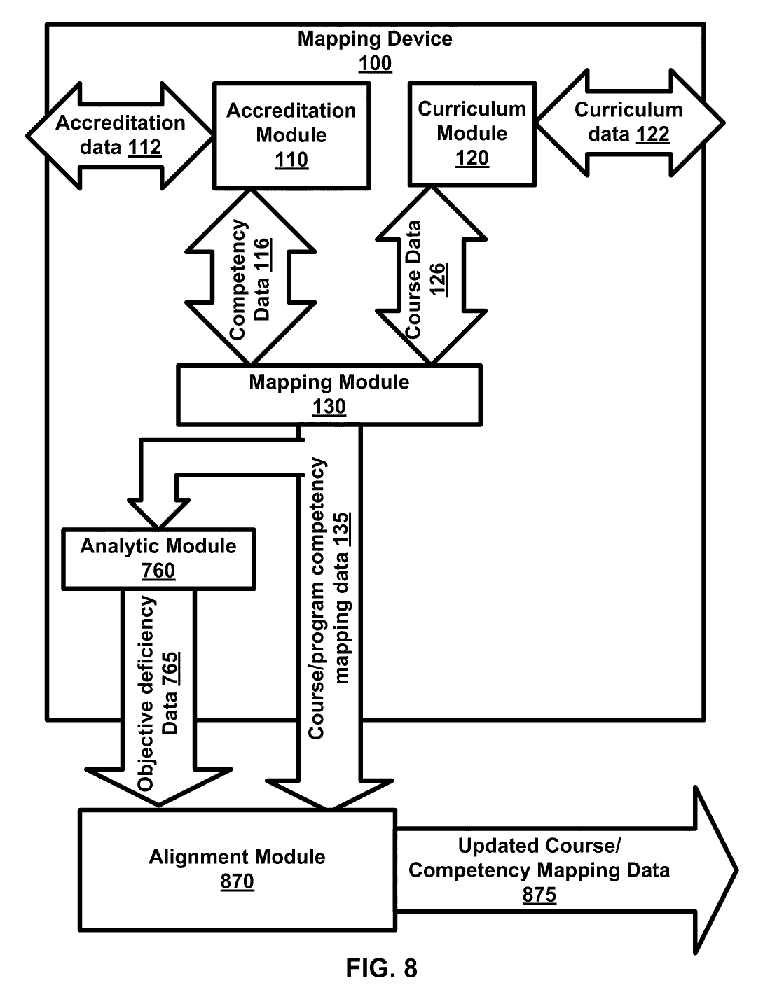

Referring to FIG. 8, mapping device 100 may include alignment module 870. According to embodiments, alignment module 870 may be configured to address one or more deficiencies. As illustrated in one aspect of embodiments at FIG. 8, alignment module 870 may be configured to address one or more objective deficiencies, for example by evaluating and/or restructuring one or more courses and/or one or more learning objectives. In embodiments, one or more deficiencies may be addressed in any suitable manner, for example by filling, supplementing, rearranging and/or maximizing implementations. In embodiments, for example, rearranging may include realigning courses within a curriculum to address deficiencies, realigning components in one or more course to address deficiencies, and the like. In embodiments, alignment module 870 may be configured to generate an output, for example updated curriculum/accreditation mapping data, such as updated course/competency mapping data 875.

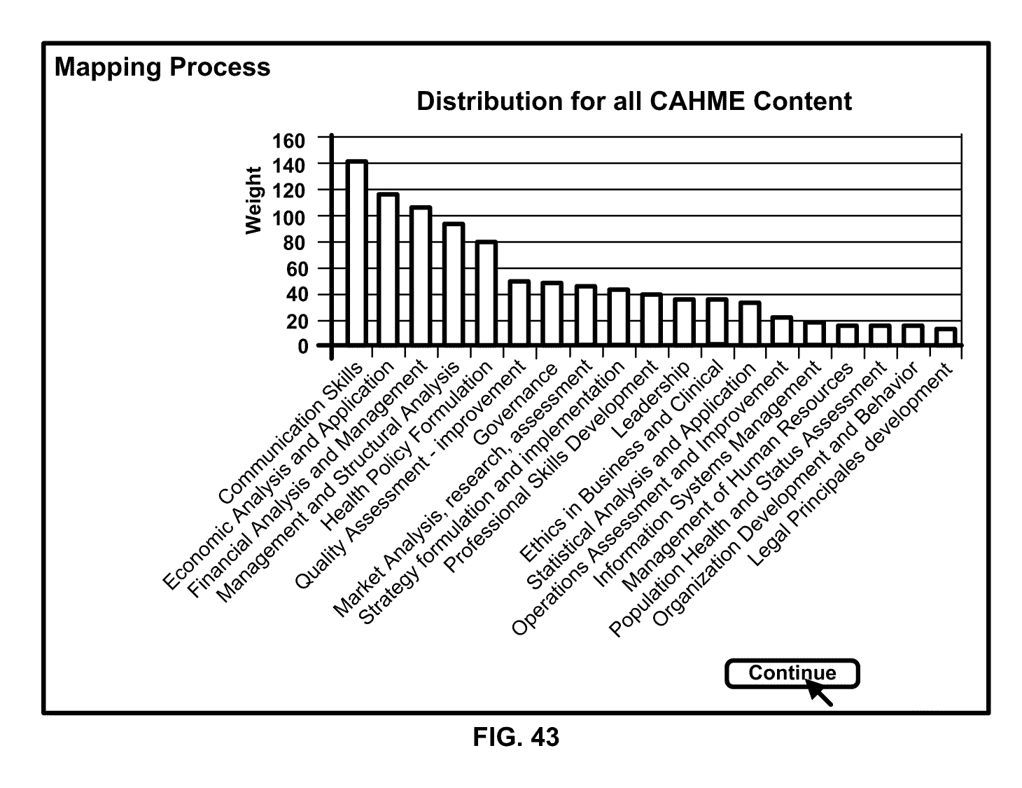

Referring to FIG. 11, mapping module 130 may generate an output, which may include accreditation/curriculum mapping data 112/122. As illustrated in one aspect of embodiments at FIG. 1, accreditation/curriculum mapping data 112/122 may include course/competency mapping data 135, which may be represented by an output graph. In embodiments, an output graph may illustrate competency data 914, which may include one or more competencies, to course content data 1016, which may include one or more course content(s), and/or to course objective data 1018, which may include one or more course objective(s). In embodiments, accreditation/curriculum mapping data 112/122 may include course/content area mapping data, which may be represented by an output graph, for example as illustrated in on aspect of embodiments at FIG. 43.

According to embodiments, mapping module 130 may generate an output graph that may highlight deficiencies, for example objective deficiencies. In embodiments, mapping module 130 may be configured to generate an output graph that may illustrate a function of one or more weight(s), for example a distribution, a sum, an average, a mean, a standard deviation and/or any other operation. In embodiments, an output graph may illustrate one or more sums of curriculum weight(s), which may include one or more academic level(s).

### Example Embodiment: Mapping Course Data to Competency Data and/or Content Area Data

Referring to examples FIG. 12 to FIG.43, a mapping process is illustrated in accordance with embodiments. According to embodiments, a mapping process may include implementing one or more operations, such as retrieving and/or recording objectives of a course, retrieving and/or recording program competencies, retrieving and/or recording accreditation standards, employing a linkage template, outputting graphs and/or any other operation. In embodiments, operations may be selected and implemented automatically, using predetermined conditions such as keywords for example, and/or may be selected and included by inputting data. In embodiments, a module may be populated using a graphical user interface,.

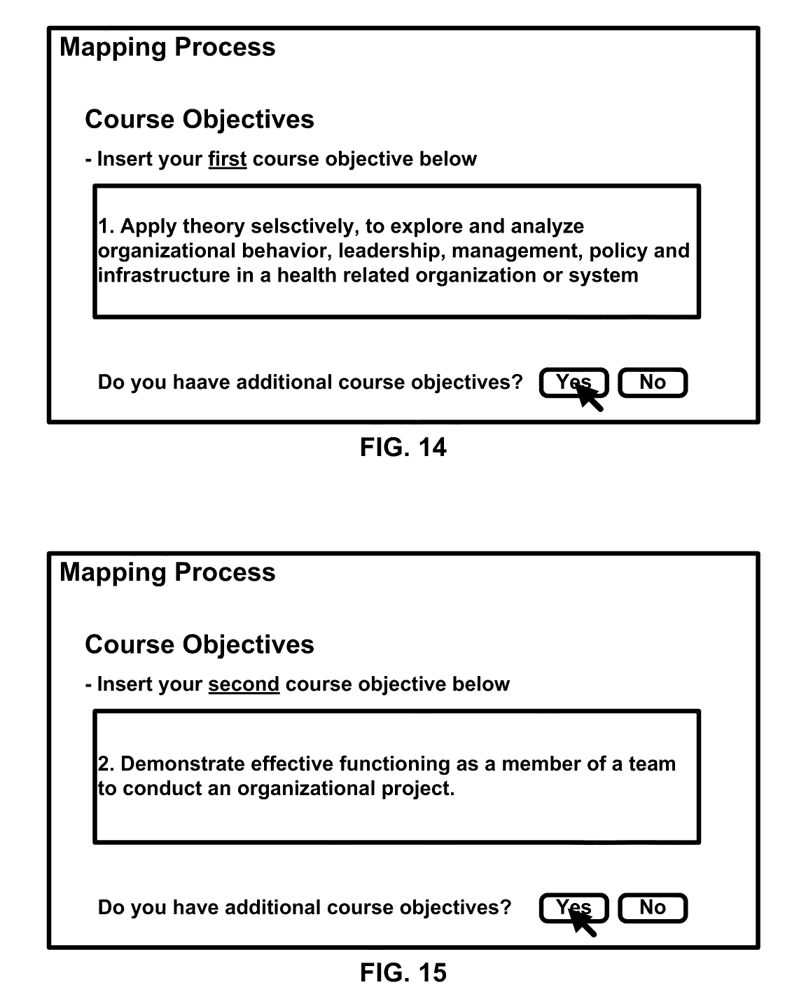

Referring to FIG. 12 to FIG. 17, a mapping process may employ curriculum data in accordance with embodiments. In embodiments, an objective of a course may be recorded, as illustrated in one aspect of embodiments at FIG. 12. In embodiments, a course may be identified, as illustrated in one aspect of embodiments at FIG. 13. In embodiments, one or more objectives may be selected and/or input, as illustrated in one aspect of embodiments at FIG. 14 to FIG. 17.

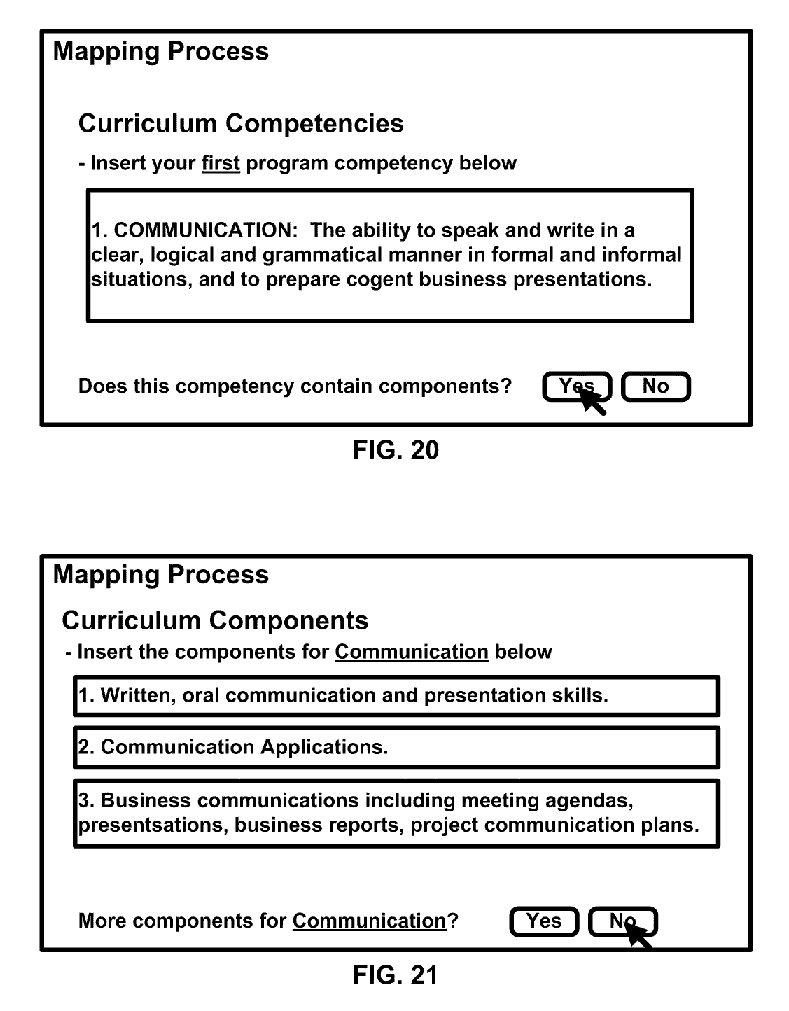

Referring to FIG. 18 to FIG. 22, a mapping process may employ accreditation data in accordance with embodiments. In embodiments, a competency may be recorded, as illustrated in one aspect of embodiments at FIG. 18. In embodiments, a competency may be identified, as illustrated in one aspect of embodiments at FIG. 19. In embodiments, one or more competencies may be selected and/or input, as illustrated in one aspect of embodiments at FIG. 20 to FIG. 22.

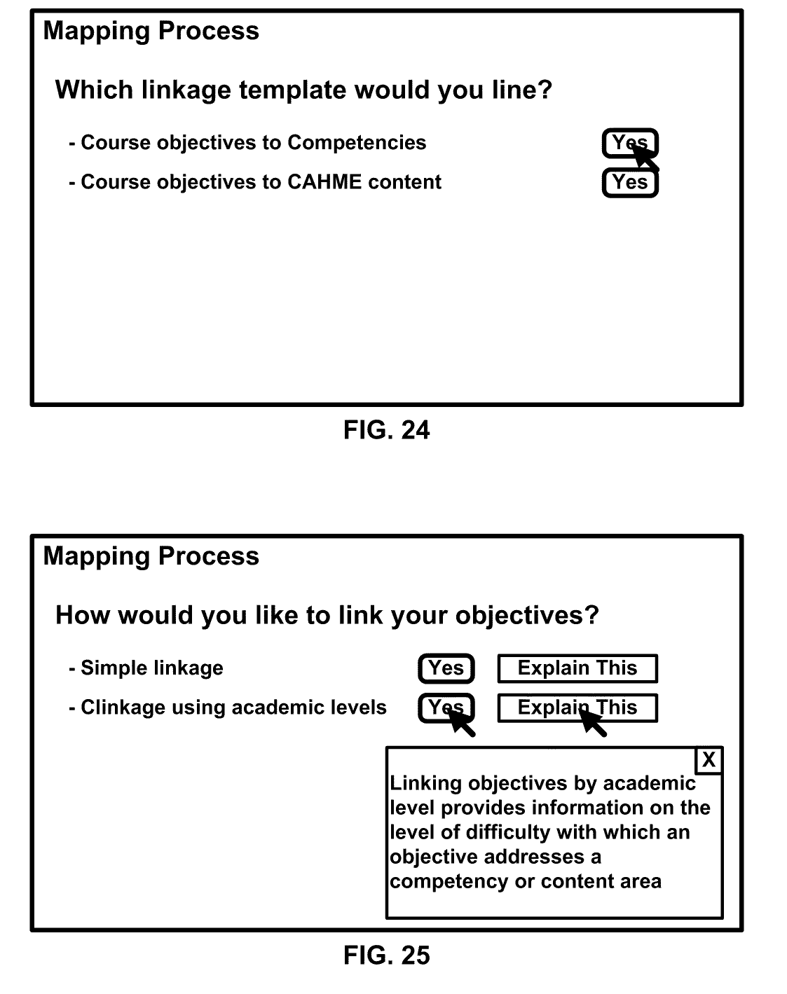

Referring to FIG. 23 to FIG. 25, and as illustrated in one aspect of embodiments at FIG. 23, a mapping process may employ a linkage template. In embodiments, a linkage template may be used to link competency data and/or content area data to course objective data, as illustrated in one aspect of embodiments at FIG. 24. In embodiments, a linkage template may be employed by implementing linkage data, which may be formed by employing a simple linkage and/or one or more academic levels, as illustrated in one aspect of embodiments at FIG. 25. In embodiments, linking course objectives by academic levels may provide linkage data related to the relative level of difficulty that a course objective may address a competency and/or a content area.

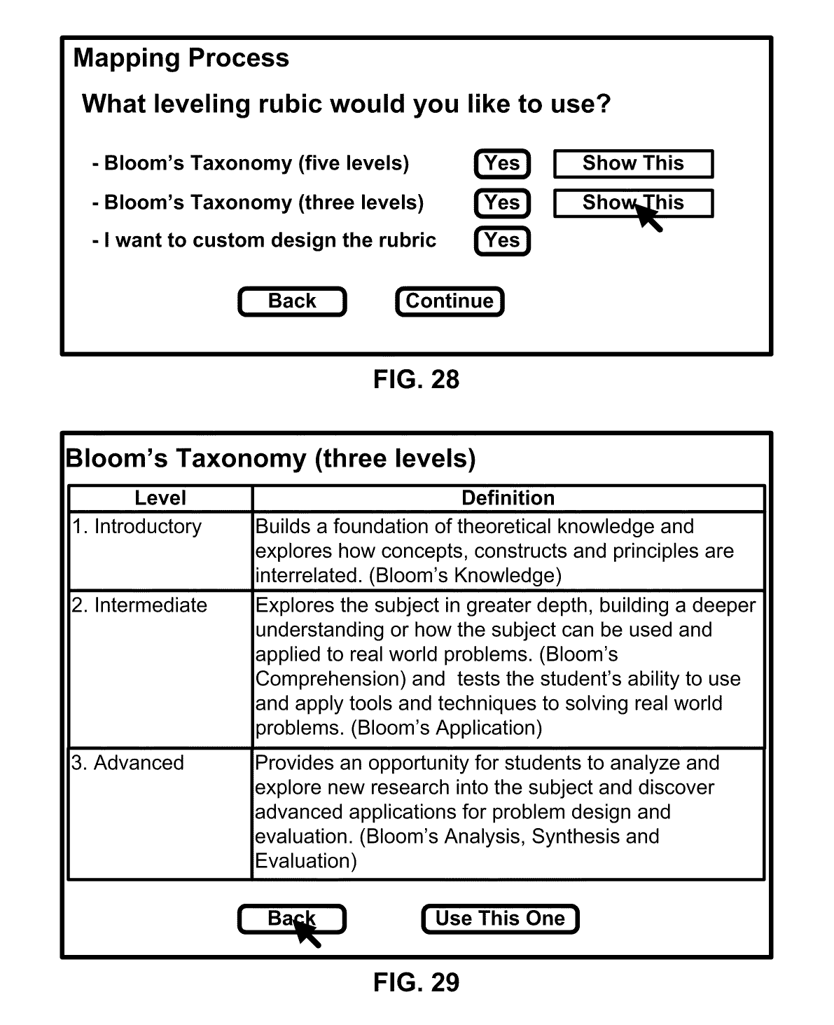

Referring to FIG. 26 to FIG. 29, a mapping process may employ a leveling rubric. In embodiments, a leveling rubric may include a multi-level taxonomy, as illustrated in one aspect of embodiments at FIG. 26 and FIG. 28. In embodiments, a 5 level bloom's taxonomy may include a knowledge level, a comprehension level, an application level, an analysis level and a synthesis and evaluation level, as illustrated in one aspect of embodiments at FIG. 27. In embodiments, a 3 level bloom's taxonomy may include an introductory level, an intermediate level and an advanced level, as illustrated in one aspect of embodiments at FIG. 29.

Referring to FIG. 30 to FIG. 31, a mapping process may include linking accreditation data to curriculum data. In embodiments, a mapping module may be configured to link competencies, for example “communication” competency including components such as “written communication”, to course objectives such as “apply theory”, as illustrated in one aspect of embodiments at FIG. 31. In embodiments, a linkage may enable determination and/or implementation of a course objective that may addresses a competency and/or a component, and/or at which academic level a course objective may address a competency and/or a component. As illustrated in one aspect of embodiments at FIG. 31, “effective demonstration” set forth in course objective (2) may address a competency “communication” and/or a component “communication applications”, at an advanced academic level (3).

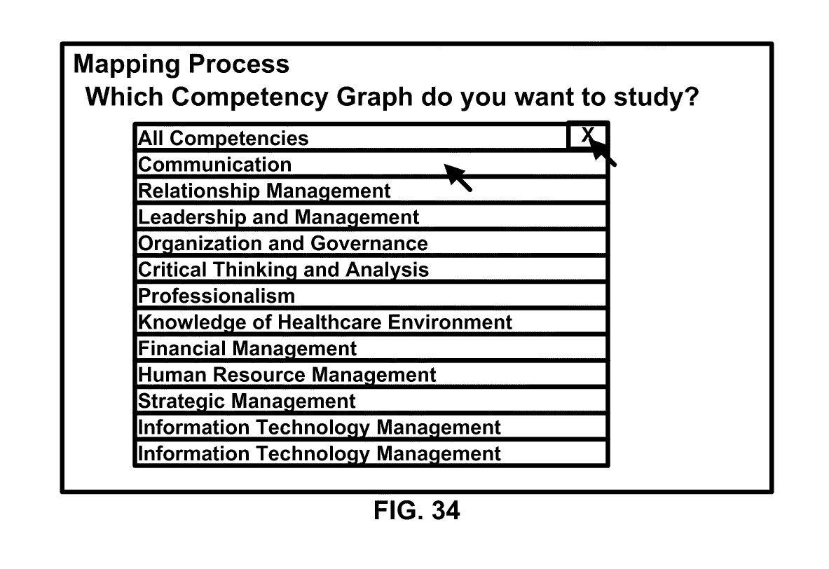

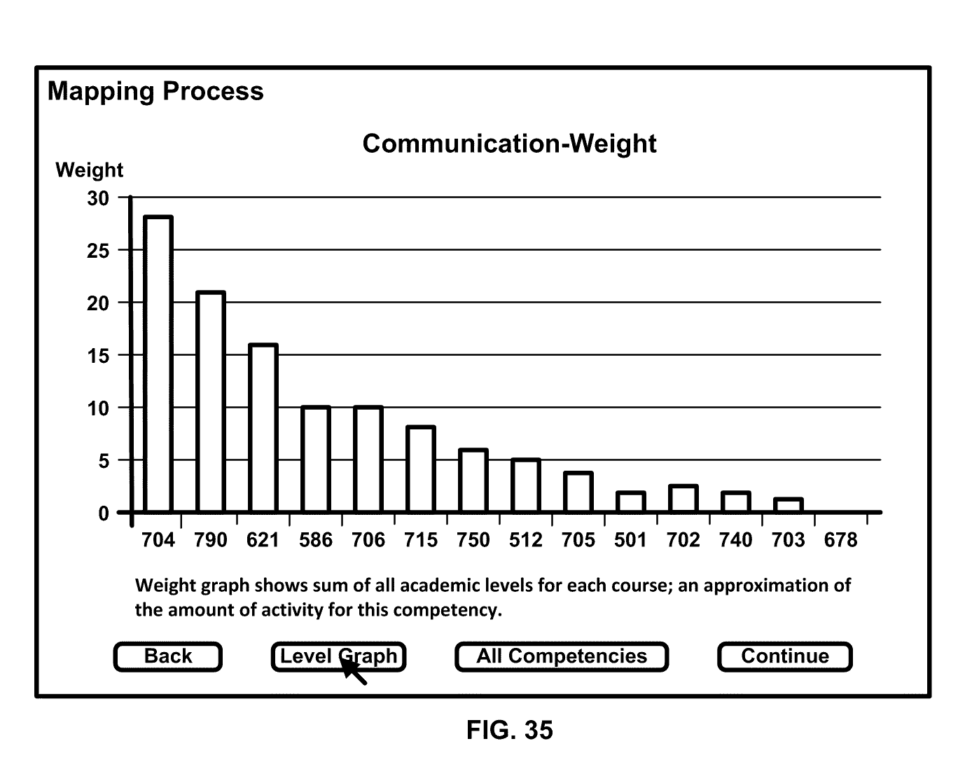

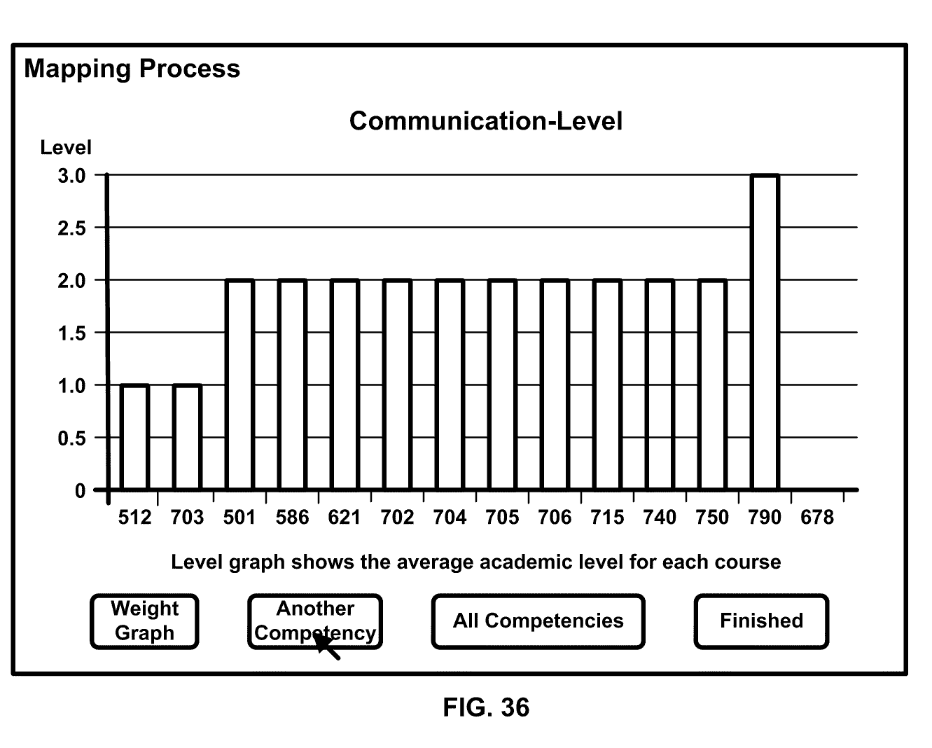

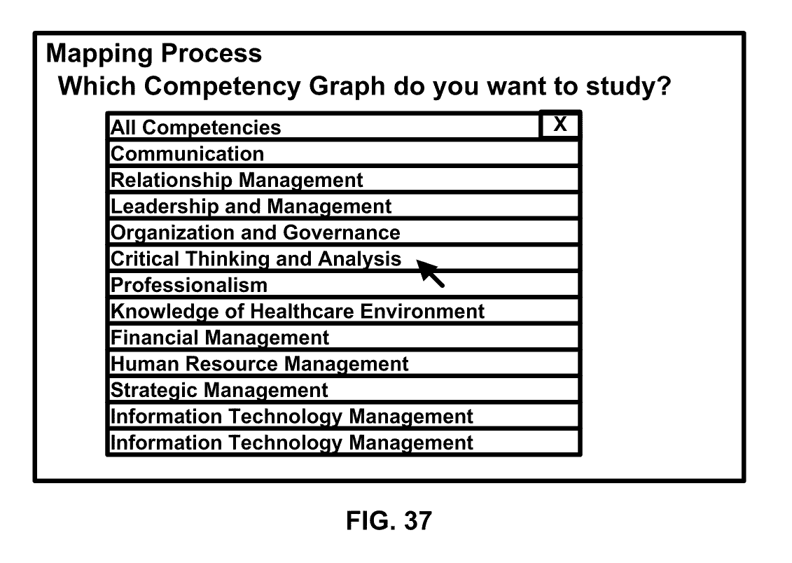

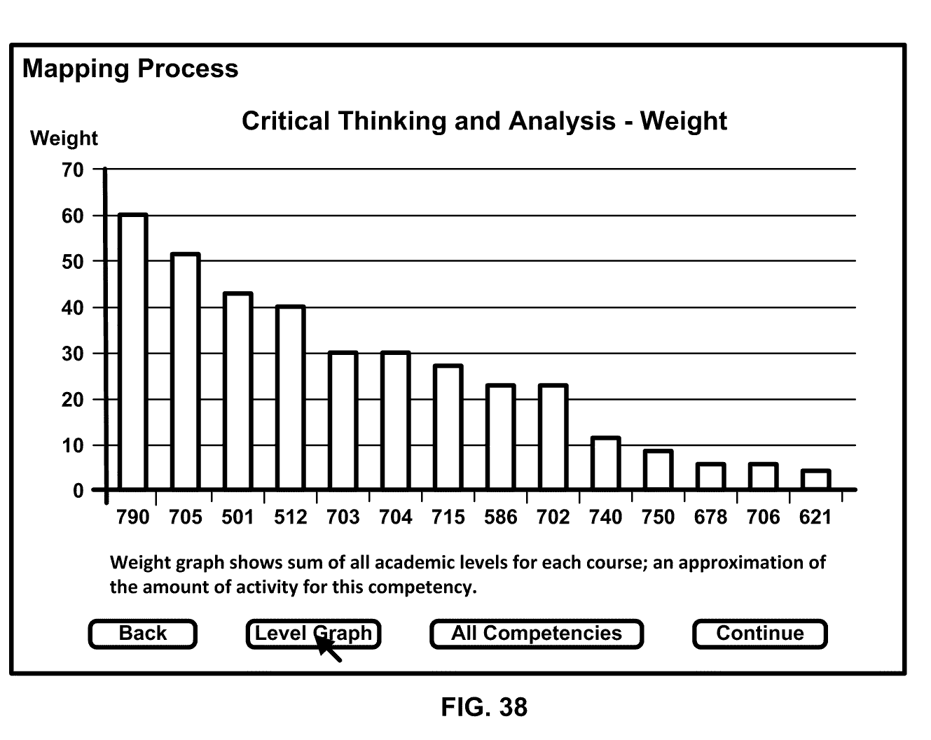

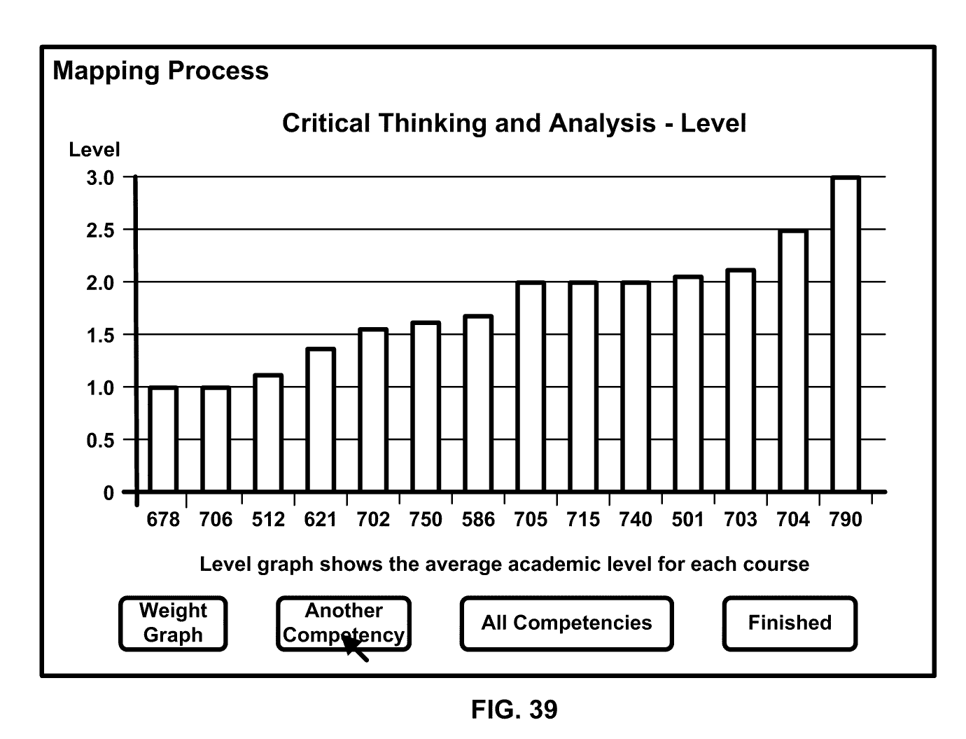

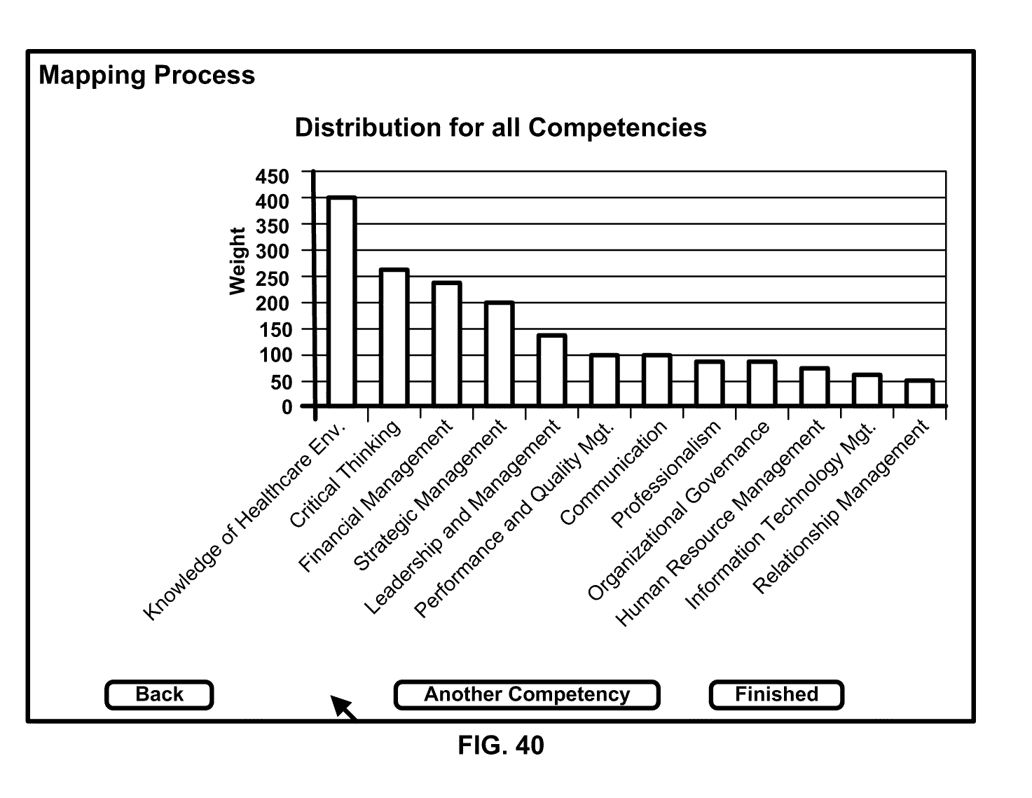

Referring to FIG. 32 to FIG. 40, a mapping process may include generating an output, which may include accreditation/curriculum mapping data. In embodiments, an output of course objective(s) to competencies may be generated. In embodiments, all competencies and/or a subset of competencies may be selected as illustrated in one aspect of embodiments at FIG. 34, FIGS. 37 and/or FIG. 40, and/or may be preselected. In embodiments, an output graph may be generated including curriculum weights, for example a sum of academic levels for each course linked to a communication competency, as illustrated in one aspect of embodiments in FIG. 35. In embodiments, any other output graph may be generated, for example illustrating an average academic level for each course linked to a communication competency, as illustrated in one aspect of embodiments at FIG. 36, and/or a graphical output related to critical thinking and analysis competencies, as illustrated in one aspect of embodiments at FIG. 38 and/or FIG. 39.

Referring to FIG. 41 to FIG. 43, a mapping process may include generating an output, which may include accreditation/content area mapping data. In embodiments, an output of course objective(s) to content area(s) may be generated. In embodiments, all content areas and/or a subset of content areas may selected as illustrated in one aspect of embodiments at FIG. 42, and/or may be preselected. In embodiments, an output graph may be generated including weights, as illustrated in one aspect of embodiments in FIG. 43.

In this specification, “a” and “an” and similar phrases are to be interpreted as “at least one” and “one or more.”

Many of the elements described in the disclosed embodiments may be implemented as modules. A module is defined here as an isolatable element that performs a defined function and has a defined interface to other elements. The modules described in this disclosure may be implemented in hardware, software, firmware, wetware (i.e hardware with a biological element) or a combination thereof, all of which are behaviorally equivalent. For example, modules may be implemented as a software routine written in a computer language (such as C, C++, Fortran, Java, Basic, Matlab or the like) or a modeling/simulation program such as Simulink, Stateflow, GNU Octave, or LabVIEW MathScript. Additionally, it may be possible to implement modules using physical hardware that incorporates discrete or programmable analog, digital and/or quantum hardware. Examples of programmable hardware include: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. Finally, it needs to be emphasized that the above mentioned technologies are often used in combination to achieve the result of a functional module.

The disclosure of this patent document incorporates material which is subject to copyright protection. The copyright owner has no objection to the facsimile reproduction by anyone of the patent document or the patent disclosure, as it appears in the Patent and Trademark Office patent file or records, for the limited purposes required by law, but otherwise reserves all copyright rights whatsoever.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above described exemplary embodiments. In particular, it should be noted that, for example purposes, the above explanation has focused on the example(s) related to accreditation data, which may include competency data and/or content area data. However, one skilled in the art will recognize that embodiments of the invention could be applied to any environment where proficiency standards may be mapped to a curriculum. For example, embodiments may be applied to the medical, legal engineering fields, etc., including mapping proficiency and or proficiency standards to a certificate curriculum.

In addition, it should be understood that any figures which highlight the functionality and advantages, are presented for example purposes only. The disclosed architecture is sufficiently flexible and configurable, such that it may be utilized in ways other than that shown. For example, the steps listed in any flowchart may be re-ordered or only optionally used in some embodiments.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

What is claimed is:

1. A computer implemented mapping device configured to map courses to at least one of program competencies and program contents comprising:
a) a accreditation module configured to retrieve from a first tangible computer readable storage medium accreditation data, each of said accreditation data having at least one learning objective, each of said learning objective having at least one of at least one competency and at least one accreditation content area, each of said at least one competency and said at least one accreditation content area having at least one component;
b) a curriculum module configured to retrieve from a second tangible computer readable storage medium at least one curriculum, each of said at least one curriculum having at least one educational program, each of said at least one educational program having at least one course, each of said at least one course having:
i) at least one course content; and
ii) at least one course objective;
c) a mapping module configured to link at least one of said at least one competency and said at least one accreditation content area to at least one of:
i) at least one of said at least one course content;
ii) at least one of said at least one course objective; or
iii) a combination thereof.

2. A mapping device according to claim 1, wherein said mapping module uses a linkage template.

3. A mapping device according to claim 2, wherein said linkage template includes at least one academic level.

4. A mapping device according to claim 1, wherein said mapping module generates an output graph.

5. A mapping device according to claim 4, wherein said output graph illustrates at least one of said at least one competency and at least one accreditation content area to at least one of said at least one course content.

6. A mapping device according to claim 4, wherein said output graph illustrates at least one of said at least one competency and at least one accreditation content area to at least one of said at least one course objective.

7. A mapping device according to claim 1, further including an analytic module configured to identify at least one objective deficiency if said at least one objective deficiency exists.

8. A mapping device according to claim 7, wherein said analytic module is configured to identify at least one discontinuity in current pedagogy when at least one predetermined threshold is not achieved.

9. A mapping device according to claim 7, wherein said analytic module is configured to identify when an academic level is not consistent with course sequencing.

10. A mapping device according to claim 7, wherein said mapping module is configured to generate an output graph that highlights said objective deficiencies.

11. A mapping device according to claim 7, further including an alignment module configured to address at least one of said at least one objective deficiency by evaluating and restructuring:
a) at least one of said at least one course; and
b) at least one of said at least one learning objective.

12. A mapping device according to claim 1, wherein said accreditation module is further configured to enable said first tangible computer readable storage medium to be populated using a graphical user interface.

13. A mapping device according to claim 1, wherein said accreditation module is further configured to enable second tangible computer readable storage medium to be populated using a graphical user interface.

14. A mapping device according to claim 1, wherein said first tangible computer readable storage medium is populated using a template.

15. A mapping device according to claim 1, wherein said mapping module employs a leveling rubric.

16. A mapping device according to claim 1, wherein said leveling rubric includes a bloom's taxonomy.

17. A mapping device according to claim 1, wherein said leveling rubric includes a 5 level bloom's taxonomy with:
a) level 1 being a knowledge level;
b) level 2 being a comprehension level;
c) level 3 being an application level;
d) level 4 being a analysis level; and
e) level 5 being a synthesis and evaluation level.

18. A mapping device according to claim 1, wherein said leveling rubric includes a 3 level bloom's taxonomy with:
a) level 1 being a introductory level;
b) level 2 being an intermediate level; and
c) level 3 being an advanced level.

19. A mapping device according to claim 1, wherein said mapping module applies a curriculum weight associated with at least one said at least one curriculum to at least one of:
a) at least one of said at least one competency;
b) at least one of said at least one content area; or
c) a combination thereof.

20. A mapping device according to claim 17, wherein said mapping module is configured to generate an output graph configured to illustrate at least one sum of curriculum weights including an academic level.

21. A mapping device according to claim 17, wherein said mapping module is configured to generate an output graph whose illustration represents a function of curriculum weights.

22. A mapping device according to claim 21, wherein said function includes at least one of the following:
a) a distribution;
b) a sum;
c) an average;
d) a mean;
e) a standard deviation; or
f) or any combination thereof.

23. A mapping device according to claim 17, wherein said first tangible computer readable storage medium” and said second tangible computer readable storage medium are the same tangible computer readable storage medium.
